(19) United States
(12) Patent Application Publication
(10) Pub. No.: US 2012/0035895 A1
(43) Pub. Date: Feb. 9, 2012

(54) CONVERGED MESH GENERATION BASED ON STATISTICAL SYSTEM AND METHOD

(76) Inventors: Kiran Kumar Gadhamsetty, Bangalore (IN); Venkateswara Gupta Araveti, Bangalore (IN)

(21) Appl. No.: 13/181,529

(22) Filed: Jul. 13, 2011

(30) Foreign Application Priority Data
Aug. 4, 2010 (IN) 2234/CHE/2010

(51) Int. Cl. G06F 17/10

(52) U.S. Cl. 703/2

(57) ABSTRACT

A system and method of generating a converged mesh is disclosed. In one embodiment, the method includes identifying a plurality of geometrical mesh parameters for a design component, obtaining order of significance for the identified geometrical mesh parameters using a first statistical technique based on one or more desired convergence parameters, obtaining number of grid elements for each of the geometrical mesh parameters by applying a second statistical technique on the obtained order of significance, and generating the converged mesh using the obtained number of grid elements for each of geometrical mesh parameters.

### RELATED APPLICATIONS

Benefit is claimed under 35 U.S.C. 119(a)-(d) to Foreign application Serial No. 2234/CHE/2010 filed in INDIA entitled “CONVERGED MESH GENERATION BASED ON STATISTICAL SYSTEM AND METHOD” by AIRBUS ENGINEERING CENTRE INDIA, filed on Aug. 4, 2010, which is herein incorporated in its entirety by reference for all purposes.

### BACKGROUND

Finite element analysis (FEA) is a powerful numerical method for solving problems in engineering and physics. Finite element analysis is particularly relevant for determining behavior of an object such as a machine part, a hydraulic system, or printed circuit board. The fundamental concept of the finite element analysis is that any physical engineering response, such as displacement, temperature, pressure, heat, or electric field, can be approximated by a discrete model composed of a set of piecewise continuous functions. These functions are defined over a finite number of sub-domains of the object.

Today, finite element analysis is typically carried out on a computer and consists of a three-step procedure: preprocessing, analysis, and post-processing. Preprocessing consists of taking data representing the object and generating there from a converged mesh (e.g., converged finite element (FE) mesh) of geometrical elements that cover the domain of the object. In analysis step, taking the element data and applying governing mathematical equations are employed in the finite element analysis to solve for behavior across the domain. Post-processing provides results of the analysis to the user in a form that can be understood, such as a graphical representation of the physical engineering response by different colors that indicate the response value across the domain.

The preprocessing step of generating an acceptable mesh for analysis is the primary bottleneck in employing finite element analysis. Present methods to obtain a converged mesh may take from hours to days, depending upon the method employed.

The accuracy of simulation results is typically sensitive to FE mesh. As the density of the FE mesh increases, accuracy of the simulation results also increase, however, this can result in increased cost of simulation run time. The existing convergence techniques are based on trial and error approach and may significantly increase the FE mesh density resulting increased simulation run time.

### BRIEF DESCRIPTION OF THE DRAWINGS

Various embodiments are described herein with reference to the drawings, wherein:

FIG. 1 illustrates a computer implemented flow diagram of an exemplary method for generating a converged mesh, according to one embodiment;

FIG. 2 illustrates a screenshot of a component for which the converged mesh needs to be generated including identified geometrical mesh parameters, according to one embodiment;

FIG. 3 illustrates a table for formation of design space for each identified geometrical mesh parameter, according to one embodiment;

FIG. 4 illustrates a table obtained using design of experiments (DoE) for the formed design space based on convergence criteria for multiple convergence parameters equivalent plastic strain (PEEQ) and von Mises stress (SMISES), according to one embodiment;

FIG. 5 illustrates a Pareto chart showing the order of significance based on obtained PEEQ response values shown in FIG. 4, according to one embodiment;

FIG. 6 illustrates a Pareto chart showing the order of significance based on obtained SMISES response values shown in FIG. 4, according to one embodiment;

FIG. 7 illustrates a computer implemented flow diagram of an exemplary method for applying one factor at a time (OFAT) on geometrical mesh parameters based on the order of significance shown in FIGS. 5-6, according to one embodiment;

FIG. 8 illustrates a table showing the application of the OFAT for geometrical mesh parameter “A”, according to one embodiment;

FIG. 9 illustrates a graph showing the convergence obtained for PEEQ response based on geometrical mesh parameter “A” values, according to one embodiment;

FIG. 10 illustrates a graph showing the convergence obtained for SMISES response based on geometrical mesh parameter “A” values, according to one embodiment;

FIG. 11 illustrates a table showing the application of OFAT for geometrical mesh parameter “B”, according to one embodiment;

FIG. 12 illustrates a graph showing the convergence obtained for PEEQ response based on geometrical mesh parameter “B” values, according to one embodiment;

FIG. 13 illustrates a graph showing the convergence obtained for SMISES response based on geometrical mesh parameter “B” values, according to one embodiment;

FIGS. 14A and B illustrate generated mesh using statistical and conventional techniques, respectively, according to one embodiment; and

FIG. 15 is a diagrammatic system view of a data processing system in which any of the embodiments disclosed herein may be performed, according to one embodiment.

The drawings described herein are for illustration purposes only and are not intended to limit the scope of the present disclosure in any way.

### DETAILED DESCRIPTION

A system and method for a converged mesh generation is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

The proposed technique uses statistical techniques for generating a converged mesh. Further, the statistical techniques include design of experiments (DoE) and one factor at a time (OFAT) to obtain fast convergence.

In the document, the terms “parameters” and “geometrical mesh parameters” are used interchangeably throughout the document. Further, the terms “mesh”, “grid”, and “discretization’ are used interchangeably throughout the document and mean the same. Furthermore, the terms “component” and “design component” are used interchangeably throughout the document. Also, the terms “desired convergence parameters” and “convergence parameters” are used interchangeably throughout the document.

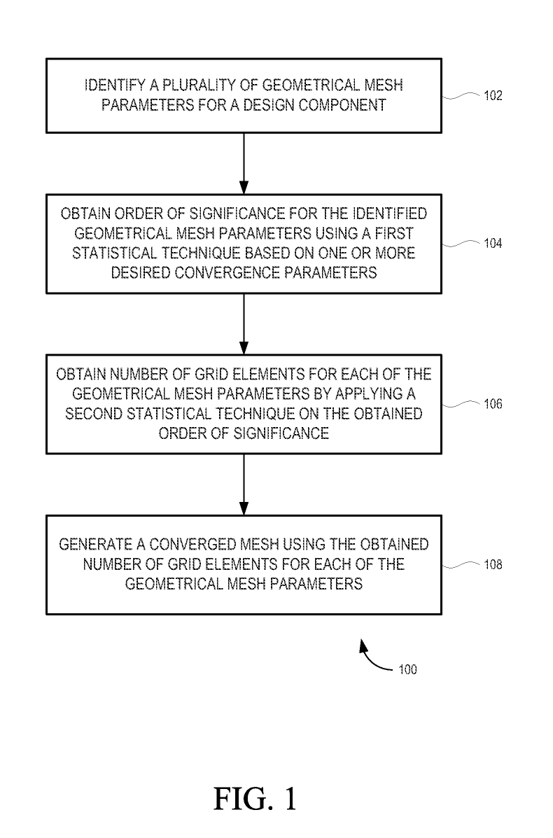

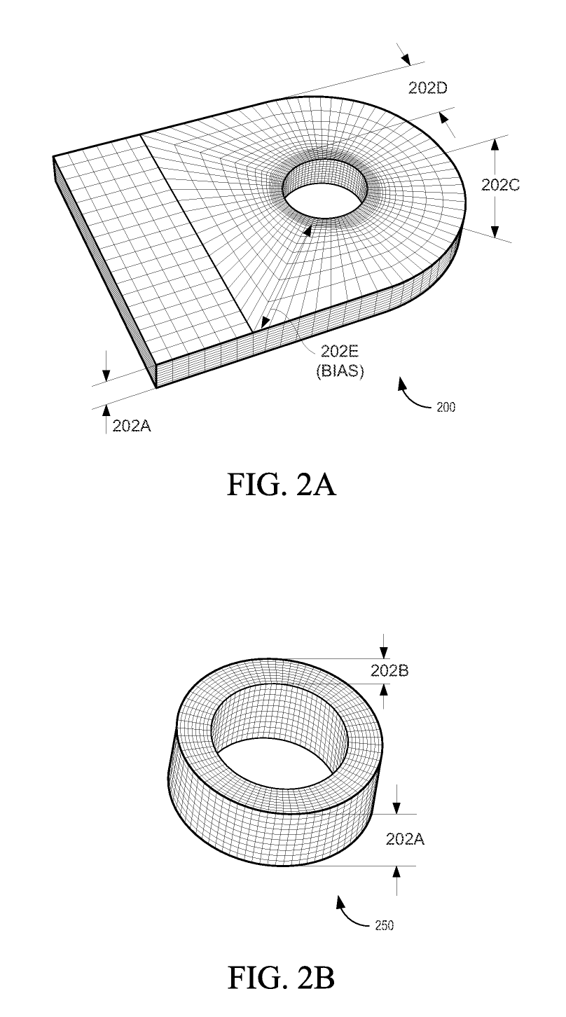

FIG. 1 illustrates a computer implemented flow diagram 100 of an exemplary method for generating a converged mesh, according to one embodiment. In one example embodiment, the converged mesh includes a converged finite element (FE) mesh. In step 102, a plurality of geometrical mesh parameters (e.g., geometrical mesh parameters 202A-E of FIG. 2A-B) for a design component are identified. For example, the design component can be an aircraft component, medical component, power generation component, electronic component, automotive component, and the like. The design component including geometrical mesh parameters is explained in detail with respect to FIG. 2A-B.

In other words, the geometrical mesh parameters are identified for the design component for which the converged mesh needs to be generated. In these embodiments, an initial number of grid elements in each of the geometrical mesh parameters is identified based on the heuristic method. In one exemplary implementation, the geometrical mesh parameters and the initial number of grid elements are identified based on the heuristic method such as experience, scrutinizing the size of the component, and the like. The objective of the statistical technique is to optimize the number of grid elements in each geometrical mesh parameter with minimum computational time and increased accuracy.

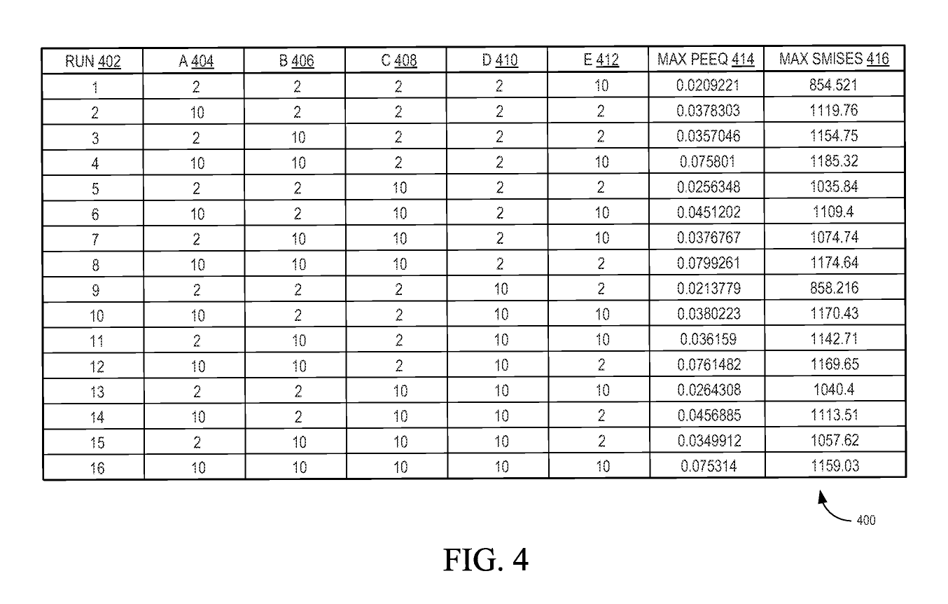

In step 104, order of significance for the identified geometrical mesh parameters is obtained using a first statistical technique based on one or more desired convergence parameters. For example, the desired convergence parameters include but not limited to equivalent plastic strain (PEEQ), von Mises stress (SMISES), displacement, heat, pressure, velocity, potential, acceleration and temperature. In one example embodiment, the first statistical technique is selected from the group consisting of design of experiments (DoE), one factor at a time (OFAT), response surface design, genetic algorithm and fuzzy logic. For example, a screening DOE with L16 matrix is used as the statistical method to determine the order of significance of geometrical mesh parameters as illustrated in FIGS. 4-6.

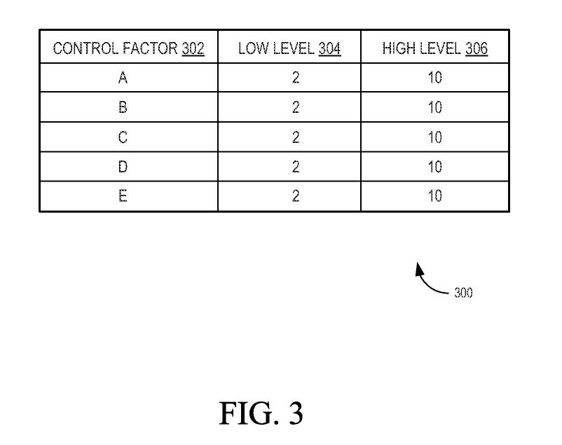

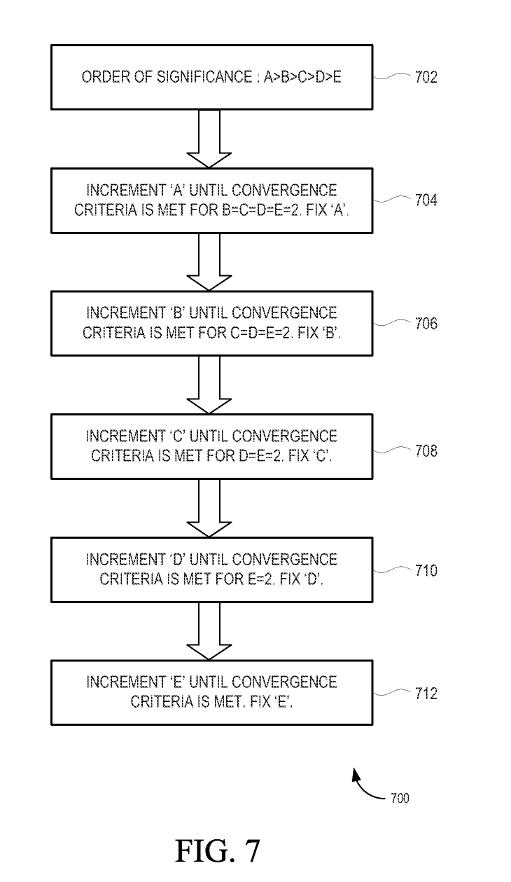

In one embodiment, the order of significance for the identified geometrical mesh parameters includes identifying one or more desired convergence parameters along with convergence criteria, identifying a design space for each geometrical mesh parameter using heuristic approach, and obtaining order of significance for the identified geometrical mesh parameters using the first statistical technique on the identified design space based on the identified one or more desired convergence parameters. In one exemplary implementation, the design space is formed using a pre-defined range of finite elements for each of the geometrical mesh parameters as illustrated in FIG. 3. The convergence criteria define a percentage difference in desired convergence parameters used for obtaining convergence in OFAT technique and the convergence criteria is explained with respect to FIGS. 7-13.

The order of significance is used to select a set of geometrical mesh parameters from the plurality of geometrical parameters which are used in OFAT technique for obtaining convergence. In other words, modification of these selected set of geometrical mesh parameters has an effect on the desired convergence parameters and modification of the remaining geometrical mesh parameters will not affect the desired convergence parameters. Once the set of geometrical mesh parameters which influence the convergence criteria is obtained then the converged mesh is generated using the set of parameters.

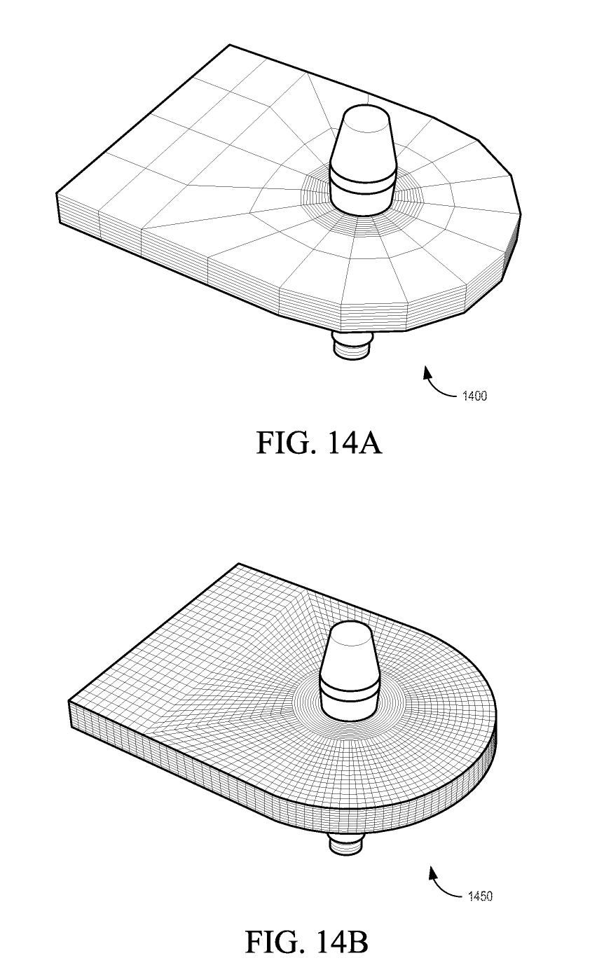

In step 106, a number of grid elements are obtained for each of the geometrical mesh parameters by applying a second statistical technique on the obtained order of significance. For example, the second statistical technique is selected from the group consisting of design of experiments (DoE), one factor at a time (OFAT), response surface design, genetic algorithm and fuzzy logic. In one example embodiment, the second statistical technique includes the one factor at a time (OFAT). The OFAT technique is explained in detail with respect to FIGS. 7-13. In step 108, the converged mesh is generated using the obtained number of grid elements for each of geometrical mesh parameters. The converged mesh is shown in FIG. 14A.

FIG. 2A-B illustrates a screenshot of a component for which the converged mesh needs to be generated illustrating identified geometrical mesh parameters, according to one embodiment. Particularly, FIG. 2A illustrates a component 200 including geometrical mesh parameters 202A, 202C, 202D and 202E. Further, FIG. 2B illustrates an exploded view 250 of the component 200 of FIG. 2A along the circumferential direction illustrating the geometrical mesh parameter 202B. For simplicity, the geometrical mesh parameters 202A, 202B, 202C, 202D and 202E are referred as A, B, C, D, and E respectively in the below description.

In one embodiment, the geometrical mesh parameters are identified based on the heuristic method. For example, the geometrical mesh parameters are selected based on experience, human intervention, and the like. The geometrical mesh parameter “A” represents the number of grid elements along the thickness of the component 200, and “B” represents the number of grid elements in the circumferential direction of the component 200. Similarly the geometrical mesh parameters C, D, and E represent the number of grid elements in other regions of the component 200. In the example embodiment illustrated in FIG. 2A-B, five parameters are selected for generating the converged mesh; however multiple parameters (N) could be selected to define the discretization space of the component 200.

FIG. 3 illustrates a table 300 for formation of design space for each identified geometrical mesh parameter, according to one embodiment. Particularly, FIG. 3 illustrates a control factor field 302, a low level field 304 and a high level field 306. In one exemplary implementation, the design space is formed using a pre-defined range of finite elements for each of the geometrical mesh parameters A-E.

The control factor field 302 displays the geometrical mesh parameters A-E. The low level field 304 and high level field 306 represents minimum and maximum number of finite elements selected for each of the corresponding geometrical mesh parameters A-E. In operation, the order of significance for the identified geometrical mesh parameters is obtained using a first statistical technique based on one or more desired convergence parameters and the design space.

For example, the first statistical technique such as the screening DoE technique is used to obtain the order of significance. In one example embodiment, the screening DoE with L16 matrix is performed on the different values of geometrical mesh parameters within the pre-defined range (i.e., the minimum and maximum values). The contribution of the geometrical mesh parameters in the estimation of a desired convergence parameter such as max PEEQ or max SMISES is scrutinized in each run to determine the order of significance. In another example embodiment, the screening DoE with L16 matrix is performed on the different values of geometrical mesh parameters to obtain the order of significance by scrutinizing the contribution of geometrical mesh parameters in the estimation of multiple desired convergence parameters. In this case, a converged mesh satisfying all the multiple convergence criteria needs to be generated.

FIG. 4 illustrates a table 400 obtained using design of experiments (DoE) for the formed design space based on convergence criteria for multiple convergence parameters PEEQ and SMISES, according to one embodiment. In one example embodiment, the convergence parameters are the output response variables for convergence.

In the example embodiment illustrated in FIG. 4, the run field 402 depicts the screening DoE performed with the five geometrical mesh parameters (A-E) in 16 simulation runs. Further, the fields 404, 406, 408, 410, and 412 depict different combination of values (i.e., within the predefined range) of the geometrical mesh parameters A-E respectively for performing the screening DoE. Furthermore, the max PEEQ field 414 and the max SMISES field 416 depict the PEEQ and SMISES response values for each run of the screening DoE. In other words, the max PEEQ field 414 and the max SMISES field 416 depict the results of the screening DoE performed with L16 matrix.

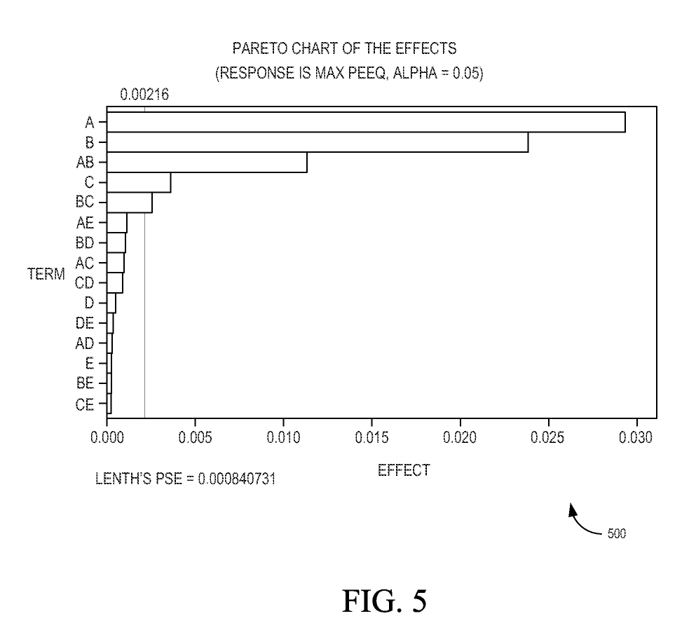

FIG. 5 illustrates a Pareto chart 500 showing the order of significance based on obtained equivalent plastic strain (PEEQ) response values shown in FIG. 4, according to one embodiment. Particularly, FIG. 5 illustrates the Pareto chart of factors (e.g., corresponding to geometrical mesh parameters A-E) obtained from the screening DoE. In the example embodiment, illustrated in FIG. 5, the geometrical mesh parameters ‘A’, ‘B’ and ‘C’ show significant influence on mesh convergence. As shown in FIG. 5, Pareto chart says that geometrical mesh parameter “A” is significant than geometrical mesh parameter “B”, “B” is significant than “C” and so on, i.e., A>B>C>D>E.

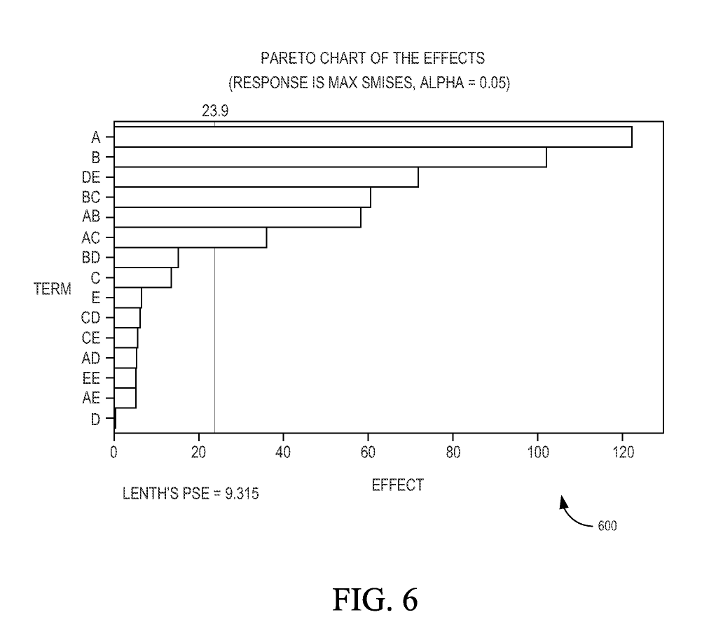

FIG. 6 illustrates a Pareto chart 600 showing the order of significance based on obtained von Mises stress (SMISES) response values shown in FIG. 4, according to another embodiment. Particularly, FIG. 6 illustrates the Pareto chart of factors (e.g., corresponding to geometrical mesh parameters A-E) obtained from the screening DoE for the SMISES response values. In the example embodiment, illustrated in FIG. 6, the geometrical mesh parameters ‘A’, ‘B’ and ‘C’ show significant influence on mesh convergence. As shown in FIG. 6, Pareto chart signifies that geometrical mesh parameter “A” is significant than geometrical mesh parameter “B”, “B” is significant than “C” and so on, i.e., A>B>C>D>E. Once the order of significance is obtained then the statistical method such as one factor at a time (OFAT) is applied to the geometrical mesh parameters based on the order of significance as shown in FIG. 7.

FIG. 7 illustrates a computer implemented flow diagram 700 of an exemplary method for applying one factor at a time (OFAT) on geometrical mesh parameters based on the order of significance shown in FIGS. 5-6, according to one embodiment. In step 702, the order of significance for the geometrical mesh parameters is obtained as A>B>C>D>E (e.g., described above with respect to FIGS. 4-6).

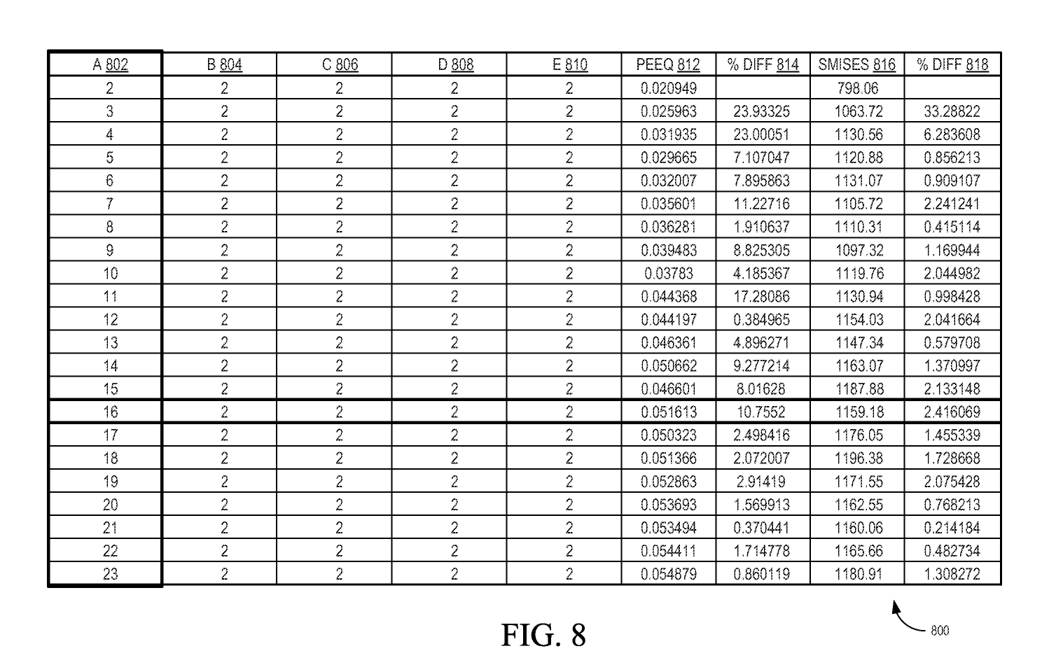

In step 704, the values of B, C, D, and E are fixed at 2 and the value of ‘A’ is increased until the convergence criteria is met. In other words, the value of A is increased by a predetermined value by keeping B, C, D, and E at a lowest value (i.e., 2, the minimum value as illustrated in FIG. 3), and then the value of A is fixed. In one example embodiment, the desired convergence parameters (i.e., the output response variables such as PEEQ and SMISES) vary as shown in FIGS. 8-10 and stabilize at a point of convergence. The point at which the output gets stabilized is a final value of the geometrical mesh parameter A. In one embodiment, the point at which the output gets stabilized (i.e., the point of convergence) is defined based on the convergence criteria. The convergence criteria is defined as a percentage difference in desired convergence parameters used for obtaining convergence as illustrated in field 814 and 818 of FIG. 8.

In step 706, the value of ‘B’ is incremented until the convergence criteria is met by fixing the values of C, D, and E at 2 (i.e., Minimum value) and using the value of “A” obtained in step 704. Then the value of B is fixed based on the convergence criteria. Similarly, in step 708 the value of ‘C’ is incremented until the convergence criteria is met by fixing the values of D, and E at 2 (Minimum value), and using the values of A and B obtained in step 704 and 706 respectively. Similarly, in steps 710 and 712, the values of D and E are fixed based on the convergence criteria. In other words, the value of each geometrical mesh parameter is fixed one at a time. In another example embodiment, the OFAT technique can also be performed only on the significant parameters A, B, and C. In other words, performing the OFAT technique on the less significant parameters (i.e., D and E) will result in a minimum value (i.e., 2) (i.e., the geometrical mesh parameters D and E will be stabilized at 2) since the parameters D and E do not have affect on the desired convergence parameters (e.g., PEEQ and SMISES).

FIG. 8 illustrates a table 800 showing the application of OFAT for geometrical mesh parameter “A”, according to one embodiment. Particularly, field 802 shows the values of “A” starting with the minimum value and increased by a predetermined value (i.e., 1) until the convergence criteria is met. Further, the fields 804, 806, 808, and 810 show the values of geometrical mesh parameters B, C, D, and E fixed at 2 (i.e., the minimum value as illustrated in FIG. 3). Furthermore, the fields 812 and 816 show the values of the convergence parameters PEEQ and SMISES for different values of “A”. In addition, the % DIFF fields 814 and 818 show the percentage difference in desired convergence parameters (PEEQ and SMISES respectively) used for obtaining the convergence. As shown in FIG. 8, the geometrical mesh parameter “A” is converged at a value of 16, i.e., the percentage differences of both the PEEQ and SMISES response values are converged at the value of 16. In another example embodiment, the desired convergence parameters are not limited to only PEEQ and SMISES response values, however, multiple desired convergence parameters can also be selected for generating a converged mesh. In this case, a converged mesh satisfying all the multiple desired convergence parameters needs to be generated.

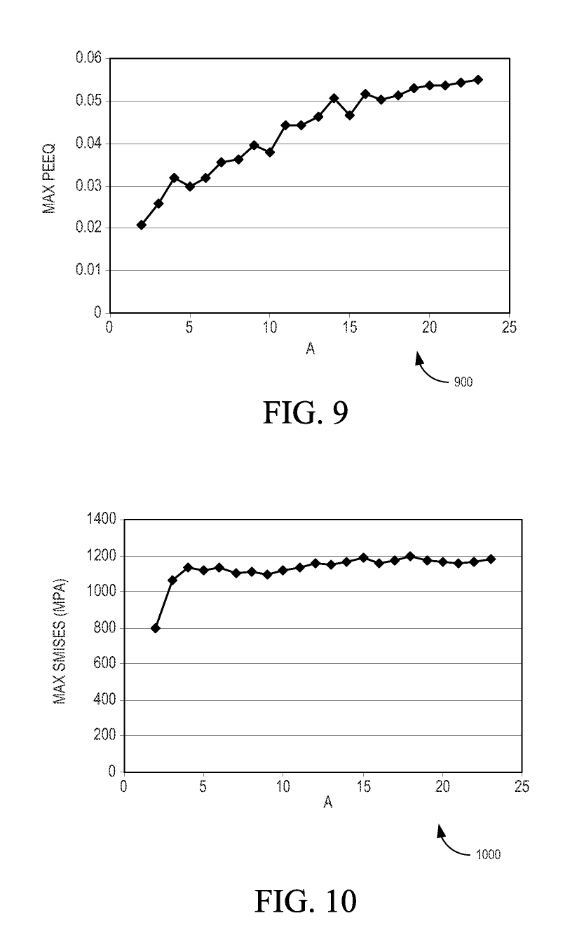

FIG. 9 illustrates a graph 900 showing the convergence obtained for PEEQ response based on geometrical mesh parameter “A” values, according to one embodiment. The x-axis represents the values of “A” and the y-axis represents the PEEQ response values corresponding to the values of “A”. As shown in FIG. 9, the values of PEEQ are converged at a value of 16.

FIG. 10 illustrates a graph 1000 showing the convergence obtained for SMISES response based on geometrical mesh parameter “A” values, according to one embodiment. The x-axis represents the values of “A” and the y-axis represents the SMISES response values corresponding to the values of “A”. As shown in FIG. 10, the SMISES response values of “A” are converged at a value of 8. However, both the convergence parameters (i.e., PEEQ and SMISES) are converged at a value of 16 and hence the value of “A” is fixed at this point.

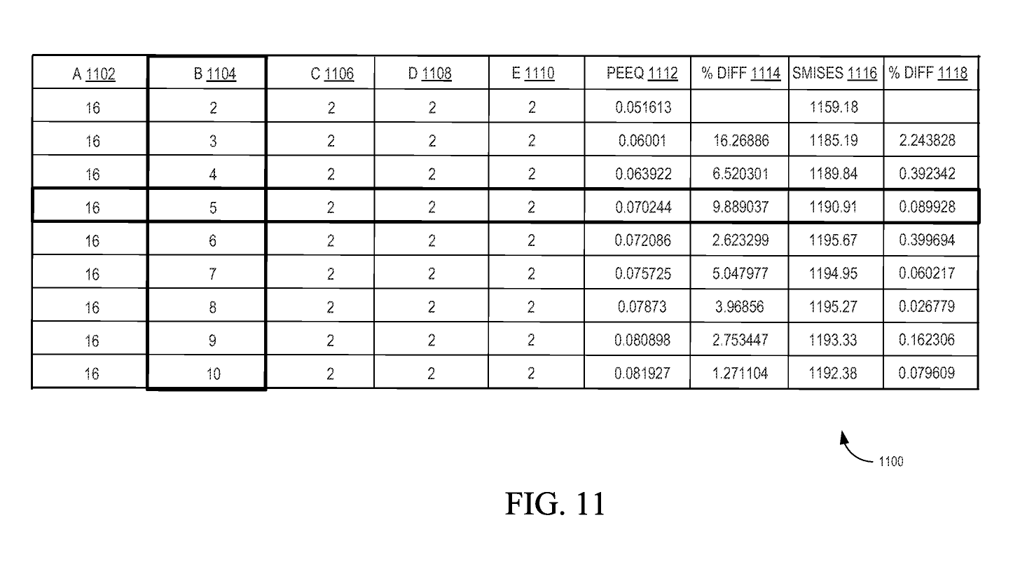

FIG. 11 illustrates a table 1100 showing the application of OFAT for geometrical mesh parameter “B”, according to one embodiment. Particularly, field 1102 shows the value of A fixed at 16. Further, the field 1104 shows the value of B starting with 2 (i.e., Minimum value) and increased by a predetermined value (i.e., 1) until the convergence criteria is met. Furthermore, the fields 1106, 1108, and 1110 show the values of geometrical mesh parameters C, D, and E fixed at 2 (i.e., the minimum value as illustrated in FIG. 3). Furthermore, the fields 1112 and 1116 show the values of the convergence parameters PEEQ and SMISES for different values of B. In addition, the % DIFF fields 1114 and 1118 show the percentage difference in desired convergence parameters (i.e., PEEQ and SMISES respectively) used for obtaining the convergence. As shown in FIG. 11, the PEEQ and SMISES response values are converged at a value of 5, i.e., the percentage differences of both the PEEQ and SMISES response values are converged at the value of 5.

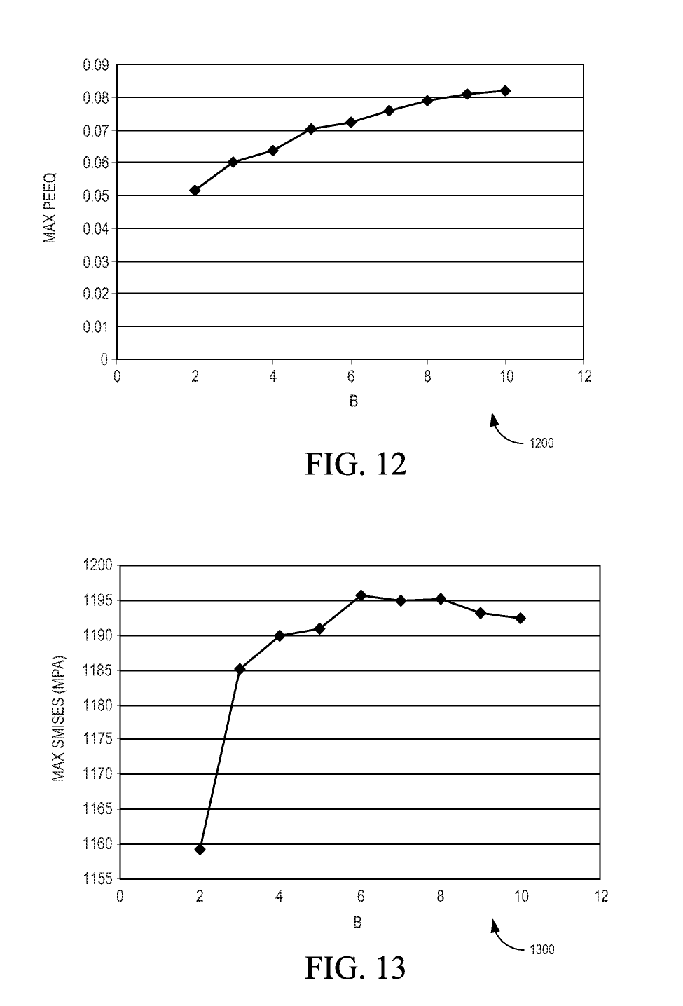

FIG. 12 illustrates a graph 1200 showing the convergence obtained for PEEQ response based on geometrical mesh parameter “B” values, according to one embodiment. The x-axis represents the values of “B” and the y-axis represents the PEEQ response values corresponding to the value of “B”. As shown in FIG. 12, the values of PEEQ are converged at a value of 5.

FIG. 13 illustrates a graph 1300 showing the convergence obtained for SMISES response based on geometrical mesh parameter “B” values, according to one embodiment. The x-axis represents the values of “B” and the y-axis represents the SMISES response values corresponding to the value of “B”. As shown in FIG. 9, the values of PEEQ and SMISES are converged at a value of 5. Both the convergence parameters (i.e., PEEQ and SMISES) are converged at the value of 5 and hence the value of B is fixed at this point. Similarly, the values of C, D, and E are fixed at 2 as mentioned above. Once the values of A, B, C, D, and E are obtained the converged mesh is generated as shown in FIG. 14A.

FIGS. 14A and B illustrate generated converged mesh using statistical technique and conventional technique, respectively, according to one embodiment. In one embodiment, the converged mesh is a converged finite element (FE) mesh. Particularly, FIG. 14A illustrates a converged mesh 1400 generated using the values of A-E obtained using the DoE and OFAT techniques. In this case, the converged mesh is generated with a maximum strain value of 7%, and SMISES stress value of 1190 MPa, and analysis time of 7 minutes. In the example embodiment illustrated in FIG. 14A, two response variables (i.e., PEEQ and SMISES) are selected for generating the converged mesh, however multiple response variables could be selected for obtaining convergence.

FIG. 14B illustrates a converged mesh 1450 generated using the conventional techniques such as trial and error approach. In this case, the converged mesh is still generated with a maximum strain value of 7%, and SMISES stress value of 1166 MPa, but the analysis time taken for the conventional technique is 1 hour compared to 7 minutes using the statistical technique described with reference to FIG. 14A.

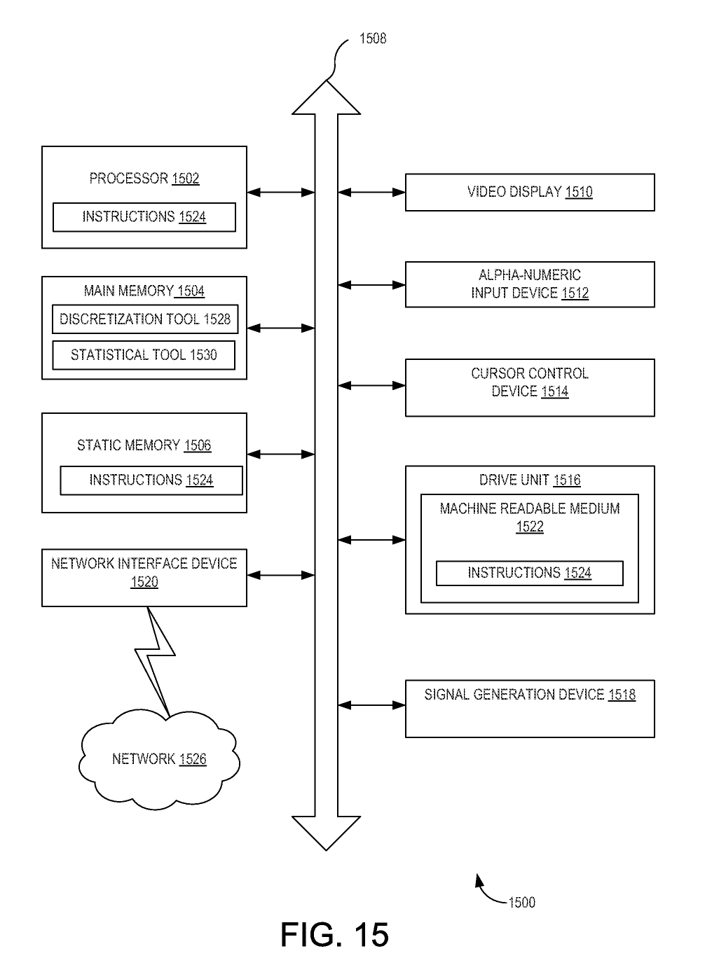

FIG. 15 is a diagrammatic system view 1500 of a data processing system in which any of the embodiments disclosed herein may be performed, according to one embodiment. Particularly, the diagrammatic system view of FIG. 15 illustrates a processor 1502, a main memory 1504, a static memory 1506, a bus 1508, a video display 1510, an alpha-numeric input device 1512, a cursor control device 1514, a drive unit 1516, a signal generation device 1518, a network interface device 1520, a machine readable medium 1522, instructions 1524 and a network 1526.

The diagrammatic system view 1500 may indicate a personal computer and/or a data processing system in which one or more operations disclosed herein are performed. The processor 1502 may be a microprocessor, a state machine, an application specific integrated circuit, a field programmable gate array, etc. The main memory 1504 may be a dynamic random access memory and/or a primary memory of a computer system. The main memory 1504 also includes a discretization tool 1528 and a statistical tool 1530 having instructions for generating a converged mesh. The static memory 1506 may be a hard drive, a flash drive, and/or other memory information associated with the data processing system.

The bus 1508 may be an interconnection between various circuits and/or structures of the data processing system. The video display 1510 may provide graphical representation of information on the data processing system. The alpha-numeric input device 1512 may be a keypad, keyboard and/or any other input device of text (e.g., a special device to aid the physically handicapped). The cursor control device 1514 may be a pointing device such as a mouse. The drive unit 1516 may be a hard drive, a storage system, and/or other longer term storage subsystem.

The signal generation device 1518 may be a BIOS and/or a functional operating system of the data processing system. The network interface device 1520 may perform interface functions (e.g., code conversion, protocol conversion, and/or buffering) required for communications to and from the network 1526 between a number of independent devices (e.g., of varying protocols). The machine readable medium 1522 may provide instructions on which any of the methods disclosed herein may be performed. The instructions 1524 may provide source code and/or data code to the processor 1502 to enable any one or more operations disclosed herein.

The system includes the processor 1502 and the memory 1506 operatively coupled to the processor 1502. The memory includes the discretization tool 1528 and the statistical tool 1530 having instructions capable of identifying a plurality of geometrical mesh parameters for a design component, obtaining order of significance for the identified geometrical mesh parameters using a first statistical technique based on one or more desired convergence design parameters, obtaining number of grid elements for each of the geometrical mesh parameters by applying a second statistical technique on the obtained order of significance, and generating the converged mesh using the obtained number of grid elements for each of geometrical mesh parameters.

An article comprising a computer readable storage medium having instructions thereon which when executed by a computing platform result in execution of the above mentioned method. The method described in the foregoing may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

In various embodiments, the methods and systems described in FIGS. 1 through 15 may enable a mesh convergence technique having an increased accuracy and reduced simulation run time. The above mentioned technique can be applicable to high density components.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method of generating a converged mesh, comprising:
identifying a plurality of geometrical mesh parameters for a design component;
obtaining order of significance for the identified geometrical mesh parameters using a first statistical technique based on one or more desired convergence parameters;
obtaining number of grid elements for each of the geometrical mesh parameters by applying a second statistical technique on the obtained order of significance; and
generating the converged mesh using the obtained number of grid elements for each of the geometrical mesh parameters.

2. The method of claim 1, wherein obtaining the order of significance for the identified geometrical mesh parameters, comprises:
identifying the one or more desired convergence parameters along with convergence criteria;
identifying a design space for each geometrical mesh parameter using heuristic approach, wherein the design space is formed using a pre-defined range of finite elements for each of the geometrical mesh parameters; and
obtaining order of significance for the identified geometrical mesh parameters using the first statistical technique on the identified design space based on the identified one or more desired convergence parameters.

3. The method of claim 1, wherein the first statistical technique and the second statistical technique are selected from the group consisting of DoE, OFAT, response surface design, genetic algorithm and fuzzy logic.

4. The method of claim 1, wherein the desired convergence parameters are selected from the group consisting of equivalent plastic strain (PEEQ), von Mises stress (SMISES), displacement, heat, pressure, velocity, potential, acceleration and temperature.

5. The method of claim 1, wherein the design component is an aircraft component, medical component, power generation component, electronic component, or automotive component.

6. The method of claim 1, wherein the converged mesh comprises a converged finite element (FE) mesh.

7. A non-transitory computer-readable storage medium for generating a converged mesh having instructions that, when executed by a computing device, cause the computing device to perform a method comprising:
identifying a plurality of geometrical mesh parameters for a design component;
obtaining order of significance for the identified geometrical mesh parameters using a first statistical technique based on one or more desired convergence parameters;
obtaining number of grid elements for each of the geometrical mesh parameters by applying a second statistical technique on the obtained order of significance; and
generating the converged mesh using the obtained number of grid elements for each of the geometrical mesh parameters.

8. The non-transitory computer-readable storage medium of claim 7, wherein obtaining the order of significance for the identified geometrical mesh parameters, comprises:
identifying the one or more desired convergence parameters along with convergence criteria;
identifying a design space for each geometrical mesh parameter using heuristic approach, wherein the design space is formed using a pre-defined range of finite elements for each of the geometrical mesh parameters; and
obtaining order of significance for the identified geometrical mesh parameters using the first statistical technique on the identified design space based on the identified one or more desired convergence parameters.

9. The non-transitory computer-readable storage medium of claim 7, wherein the first statistical technique and the second statistical technique are selected from the group consisting of DoE, OFAT, response surface design, genetic algorithm and fuzzy logic.

10. The non-transitory computer-readable storage medium of claim 7, wherein the desired convergence parameters are selected from the group consisting of equivalent plastic strain (PEEQ), von Mises stress (SMISES), displacement, heat, pressure, velocity, potential, acceleration and temperature.

11. The non-transitory computer-readable storage medium of claim 7, wherein the design component is an aircraft component, medical component, power generation component, electronic component, or automotive component.

12. The non-transitory computer-readable storage medium of claim 7, wherein the converged mesh comprises a converged finite element (FE) mesh.

13. A system for generating a converged mesh, comprising:
a processor; and
memory operatively coupled to the processor, wherein the memory includes a discretization tool and a statistical tool having instructions capable of:
identifying a plurality of geometrical mesh parameters for a design component;
obtaining order of significance for the identified geometrical mesh parameters using a first statistical technique based on one or more desired convergence parameters;
obtaining number of grid elements for each of the geometrical mesh parameters by applying a second statistical technique on the obtained order of significance; and
generating the converged mesh using the obtained number of grid elements for each of the geometrical mesh parameters.

14. The system of claim 13, wherein obtaining the order of significance for the identified geometrical mesh parameters, comprises:
identifying the one or more desired convergence parameters along with convergence criteria;
identifying a design space for each geometrical mesh parameter using heuristic approach, wherein the design space is formed using a pre-defined range of finite elements for each of the geometrical mesh parameters; and
obtaining order of significance for the identified geometrical mesh parameters using the first statistical technique on the identified design space based on the identified one or more desired convergence parameters.

15. The system of claim 13, wherein the first statistical technique and the second statistical technique are selected from the group consisting of DoE, OFAT, response surface design, genetic algorithm and fuzzy logic.

16. The system of claim 13, wherein the desired convergence parameters are selected from the group consisting of equivalent plastic strain (PEEQ), von Mises stress (SMISES), displacement, heat, pressure, velocity, potential, acceleration and temperature.

17. The system of claim 13, wherein the design component is an aircraft component, medical component, power generation component, electronic component, or automotive component.

18. The system of claim 13, wherein the converged mesh comprises a converged finite element (FE) mesh.
